(19) United States
(12) Patent Application Publication
(10) Pub. No.: US 2025/0390994 A1
(43) Pub. Date: Dec. 25, 2025

(54) METHOD FOR ADAPTIVE DECONVOLUTION OF IMAGES

(71) Applicant: ABBERIOR INSTRUMENTS GMBH, Gottingen (DE)

(72) Inventors: Frederic WEIDLING, Gottingen (DE); Matthias REUSS, Gottingen (DE)

(21) Appl. No.: 19/222,067

(22) Filed: May 29, 2025

(30) Foreign Application Priority Data
Jun. 21, 2024 (DE) 10 2024 117 663.6

(51) Int. Cl. G06T 5/73

(52) U.S. Cl. CPC G06T 5/73; G06T 2207/10056

(57) ABSTRACT

The invention relates to the light microscopic acquisition of image data and the generation of deconvolved images. The deconvolution of an image is controlled by performing deconvolution steps in parallel on two control images, the results of which are compared with each other. Depending on the result of the comparison, the deconvolution rule for the actual image to be deconvolved is adapted. Other aspects relate in particular to the consideration of background and unwanted emissions from the sample during deconvolution.

### CROSS-REFERENCE TO RELATED APPLICATION

This application claims priority to German Patent Application No. 10 2024 117 663.6 filed Jun. 21, 2024, the disclosure of which is incorporated herein by reference in its entirety.

### TECHNICAL FIELD OF THE INVENTION

The invention is directed to a method and a device, in particular to a fluorescence microscopy method and a fluorescence microscope, for obtaining high-resolution images using an iterative deconvolution method. Compared to the methods known from the prior art, the invention is characterized by a reduction or suppression of artifacts in the images resulting from the deconvolution.

### STATE OF THE ART

If images of an object are recorded by means of an optical system, the image essentially results from an object function, which corresponds to a distribution of the signal sources in the object, and a function which is characteristic of the imaging system, as well as from further, random components which can be described as noise. The function characteristic of the imaging system is often referred to as the point spread function, as in this application. If this point spread function does not depend on the location in the object, then the image acquisition, if no noise is present, can be described mathematically as a convolution of the object function with the point spread function. If the object function and the image are each represented as the sum of frequency components, different frequency components with different modulations and possibly different phase shifts are transmitted during the imaging process, whereby some frequencies, including as a rule all frequencies above a cut-off frequency, are not transmitted at all. In frequency space, the transfer of the frequency components of the object function into frequency components of the image can be described as multiplication with a frequency transfer function of the image, which results as the Fourier transform of the point spread function. The reverse operation to convolution is called deconvolution. In the ideal case of a noise-free image and a location-independent point spread function, all frequency components that were transferred into the image with any non-zero modulation are completely reconstructed during deconvolution. However, if noise is present in the image, noise components at frequencies that were transmitted with low modulation during the imaging process are amplified during deconvolution.

In the context of image processing in the sense of an approximate reconstruction of object functions, the terms convolution and deconvolution are now used in a broader sense than mentioned above. In particular, deconvolution subsumes all operations by means of which object functions are approximately reconstructed from images and which do not or do not exclusively concern the reduction of noise in the image. This applies regardless of whether the point spread function does not depend on the location in the object or whether it depends on the location in the object, as is the case with many real imaging processes. In this application, the term deconvolution is used in a broad sense.

Iterative deconvolution methods are often used in connection with the approximate reconstruction of object functions. Even when iterative deconvolution methods are used, noise has a negative impact on the results of image processing. In particular, artifacts can occur in the processed images which, unlike the original noise, not only degrade the image quality but also distort the image content.

Expectation-maximization algorithms, or EM algorithms for short, form a class of iterative deconvolution methods. A special EM algorithm is known as Richardson-Lucy deconvolution or RL deconvolution for short. RL deconvolution is based primarily on the independent publications “Bayesian-Based Iterative Method of Image Restoration” (Richardson, W. H.; J. Opt. Soc. Am. 62, 55-59 (1972)) and “An iterative technique for the rectification of observed distributions” (Lucy, L. B.; Astronomical Journal. 79 (6) (1974)). The RL deconvolutions are adapted to images in which noise is present according to a Poisson statistic, as is regularly the case in fluorescence microscopy. An essential element of a Richardson-Lucy deconvolution is the point-wise formation of a ratio between the noisy image to be deconvolved and the image, which results from an estimate of an object function given in a stage of iteration and the assumed imaging process. The values of these ratios determine the estimate of the object function in the following iteration stage.

If the ratio is 1, the measured image and the estimate are consistent. The deviations of the ratio from 1 determine whether the estimated values in the following iteration stage are larger or smaller.

In the publication “Richardson-Lucy deconvolution as a general tool for combining images with complementary strengths” (Ingaramo, M. et al.; Chemphyschem. 2014 Mar. 17;15 (4): 794-800; DOI: 10.1002/cphc.20130083), an extension of Richardson-Lucy deconvolution to a joint deconvolution, referred to as “joint Richardson-Lucy deconvolution”, of multiple images of the same scene is presented. The images can be acquired using different imaging techniques. One example refers to simulated data of an image taken with a confocal microscope with a detector located at the imaging focus, which spatially resolves a diffraction limited spot; the corresponding microscopy technique is referred to as image scanning microscopy.

In the publication “Multi-images deconvolution improves signal-to-noise ratio on gated stimulated emission depletion microscopy” (Castello, M. et al.; Appl. Phys. Lett. 8 Dec. 2014; 105 (23): 234106. DOI: 10.1063/1.4904092) is shown that multiple images of the same object can be obtained from a gated cw-STED image acquisition, especially in conjunction with time-resolved fluorescence acquisition. Images generated from early photons captured immediately after excitation have a lower resolution and a higher signal-to-noise ratio than images captured from later photons. Multi-image deconvolution is performed on such images. For this purpose, a generalized Richardson-Lucy deconvolution is used, which is formulated in the following discrete form:

$${x}^{k + 1} = {x}^{k} \cdot ( {\sum }_{l = 1}^{L} {H}_{l}^{T} \frac{{y}_{i}}{{H}_{l} {x}^{k} + {b}_{l}} ) .$$

The index I denotes an image number, Hidenotes an effective point spread function on which the corresponding imaging process of the image is based, and bᵢ denotes a location-dependent background term. This was not known a priori. It was set to the value 0 in all cases considered in the publication, i.e. the deconvolutions were actually performed without explicit consideration of a background.

The publication “Reconstructing the image scanning microscopy dataset: an inverse problem” (Zunino, A. et al.; 2023 Inverse Problems 39 064004; DOI: 10.1088/1361-6420/accdc5) deals with image scanning microscopy. Image scanning microscopy can be understood as a simultaneous acquisition of a number of images of the same scene, where the number of images corresponds to the number of detector elements of the spatially resolving detector. A joint deconvolution of this number of images, referred to as multi-image deconvolution, is shown. Among other things, the publication proposes to add a background term to the model describing an imaging process, which describes any kind of unwanted emission. Examples of unwanted emissions or emission sources are molecules outside the focus, unspecific staining and autofluorescence. For a model without explicit consideration of the background, the following formula is given for an iterative deconvolution:

$${o}_{k + 1} ( {x}_{s} ) = {o}_{k} ( {x}_{s} ) \int h ( - {x}_{s} \vert {x}_{d} ) * ( \frac{i ( {x}_{s} \vert {x}_{d} )}{o ( {x}_{s} ) * h ( {x}_{s} \vert {x}_{d} )} ) {dx}_{d} ,$$

which describes a gradient descent method. The index d denotes a single detector of a SPAD array, the index s denotes a coordinate in an image i or in an estimate o of a location-dependent object function to be reconstructed. If the background b, which is also formulated as location-dependent, is now explicitly taken into account, the following modified formula results for the corresponding gradient descent method:

$${o}_{k + 1} ( {x}_{s} ) = {o}_{k} ( {x}_{s} ) \int h ( - {x}_{s} \vert {x}_{d} ) * ( \frac{i ( {x}_{s} \vert {x}_{d} )}{o ( {x}_{s} ) * h ( {x}_{s} \vert {x}_{d} ) + b ( {x}_{s} \vert {x}_{d} )} ) {dx}_{d} ,$$

This method also involves a point-by-point formation of a ratio between the noisy image (i) to be deconvolved and the image resulting from an estimate of an object function (o) in one stage of the iteration from the assumed imaging process. It is determined and shown that in the case of multi-image deconvolution according to the first-mentioned formula without explicit consideration of a background, the brightness (photon flux) summed over all spatial coordinates remains the same from iteration stage to iteration stage. It is determined that this condition is not fulfilled for a deconvolution according to the second mentioned formula with explicit consideration of the background. Deconvolved microscope images are shown using multi-image deconvolution. However, deconvolution with explicit consideration of a background is not discussed further. In addition to the aforementioned aspects of the publication, there are various other aspects that will not be discussed here.

In the publication “Two-Photon Excitation STED Microscopy with Time-Gated Detection” (Coto Hernández, I. et al.; Sci Rep 6, 19419 (2016); DOI: 10.1038/srep19419), image acquisition using STED with two-photon excitation and gated detection and an image enhancement or image deconvolution process for the acquired images are described. As in the above-mentioned publication “Multi-images deconvolution improves signal-to-noise ratio on gated stimulated emission depletion microscopy”, several images are generated from the image data. In addition, a background is determined from data on photons recorded with a large time interval after excitation. This background is determined for a multi-image deconvolution according to the rule

$${x}^{k + 1} = {x}^{k} \cdot ( {\sum }_{l = 1}^{L} {H}_{l}^{T} \frac{{y}_{i}}{{H}_{l} {x}^{k} + {b}_{l}} )$$

explicitly taken into account

A deconvolution rule corresponding to the above except for one normalization term is also described much earlier in the publication “Image restoration methods for the large binocular telescope (LBT)” (Bertero, M. and Boccacci, P.; Astronomy and Astrophysics Supplement Series, 147 (2), 323-333. (2000); DOI: 10.1051/aas:2000304) for multi-image deconvolution, in particular for multi-image deconvolution of astronomical image data with Poisson noise obtained at the Large Binocular Telescope (LBT). An unfavorable property of this LR or EM deconvolution is its slow convergence, which requires a high computational effort. In order to address this problem, referring to the publication “Accelerated image reconstruction using ordered subsets of projection data” (Hudson, H M and Larkin, R S.; IEEE Trans Med Imaging. 1994;13 (4): 601-9.; DOI: 10.1109/42.363108.), it is proposed to perform an ordered subsets EM. A concrete algorithm is proposed. In this algorithm, too, an essential step is forming a ratio between a noisy image or image section to be deconvolved and the image or image section resulting from an estimate of an object function or a section of an object function in a stage of iteration from the assumed imaging process.

The publication “Focus image scanning microscopy for sharp and gentle super-resolved microscopy” (Tortarolo, G. et al.; Nat Commun 13, 7723 (2022); DOI: 10.1038/s41467-022-35333-y) describes how a background can be separated from the signal of the focal plane in images from an image scanning microscope. This background is explicitly taken into account in the context of an iterative multi-image deconvolution in a point-by-point formation of a ratio between the noisy image to be deconvolved and the image resulting from an estimate of an object function in one stage of the iteration from the assumed imaging process. A weight function is also used during deconvolution, which is the inverse of a so-called fingerprint function and which takes into account the different signal-to-noise ratios of the individual images assigned to the individual detector elements of the image scanning microscope during deconvolution.

In the publication “A robust and versatile platform for image scanning microscopy enabling super-resolution FLIM” (Castello, M. et al.; Nat Methods 16, 175-178 (2019); DOI: 10.1038/s41592-018-0291-9), a multi-image deconvolution of images from an image scanning microscope is also described, among other things. A Fourier ring correlation analysis is carried out to determine the image resolution. Image pairs for their determination are obtained quasi-simultaneously during image data acquisition by means of “pixel-dwell-time splitting”.

In the publication “Fourier ring correlation simplifies image restoration in fluorescence microscopy” (Koho, S. et al.; Nat Commun 10, 3103 (2019); DOI: 10.1038/s41467-019-11024-z), the method of Fourier ring correlation and possibilities for using Fourier ring correlation in the deconvolution of images are discussed. The Fourier ring correlation is a function dependent on a radial coordinate that describes the correlation of equal radial spatial frequency components in two images to be compared. It is typically used to obtain information about both the point spread function or optical transfer function (OTF) on which the image acquisition is based and about noise components as a function of the radial spatial frequency from two images of the same scene whose radial frequency components are compared with each other. The publication describes a division of an image into sub-images, which can be understood as independent images of the same scene. Among other things, the determination of a Fourier ring correlation from these sub-images, the estimation of a point spread function from this Fourier ring correlation, the use of the point spread function determined in this way in connection with an iterative deconvolution and the evaluation of the quality of deconvolved images by determining the Fourier ring correlation from sub-images of the deconvolution results in the individual iterations are described. According to the publication, the Fourier ring correlation can be used in this way to determine a meaningful termination criterion for an iterative deconvolution. The publication also describes an RL deconvolution with explicit consideration of a background term and compares the result of it with the result of a deconvolution of the same image data without explicit consideration of the background.

In the publication “Single image Fourier ring correlation” (Rieger, B. et al.; Opt. Express 32, 21767-21782 (2024)), a different method for obtaining two images to determine a Fourier ring correlation from an image acquisition with Poisson noise is described. Here, the values assigned to the individual pixels are divided into two images according to a random process. In this way, two images are obtained, each of which is also affected by Poisson noise. It is shown that a Fourier ring correlation obtained from such partial images corresponds to one obtained from two corresponding images taken individually. With reference to the above-mentioned publication “Fourier ring correlation simplifies image restoration in fluorescence microscopy”, it is pointed out that the Fourier ring correlation determined in this way can be used as a stop criterion in an iterative deconvolution, although it is expressly pointed out that it is necessary that the division into two images takes place, if the image values follow a Poisson statistic, which is the case with the raw data after correction of an offset and consideration of an image amplification

European patent EP 3 624 047 B1 describes an iterative deconvolution method in which a signal-to-noise ratio, a location-dependent signal, a location-dependent noise and a location-dependent background term b(xᵢ) are each determined for an entire image depending on the location in the image, the location-dependent background term being determined from the signal-to-noise ratio in the specific case. Furthermore, a noise parameter β(SNR(xᵢ)) is determined from a signal-to-noise ratio, which serves as a local regularization parameter of a regularization function V(xᵢ) during iterative deconvolution. Deconvolution can be performed according to the following formula:

$${f}^{( k + 1 )} ( {x}_{i} ) = \frac{{f}^{( k )} ( {x}_{i} )}{1 + β ( SNR ( {x}_{i} ) ) V ( {x}_{i} )} {h}^{T} ( {x}_{i} ) * ( \frac{I ( {x}_{i} )}{[ h * {f}^{( k )} ] ( {x}_{i} ) + b ( {x}_{i} )} ) .$$

The parameter β(SNR(xᵢ)) takes on values that are monotonically dependent on the local signal-to-noise ratio within a range between two threshold values and assume the same constant value outside this range between the threshold values as at the neighboring threshold value. The iterative deconvolution process can be aborted when a convergence criterion is reached, in which the sum of the absolute values of the differences between the pixel-by-pixel values of the deconvolved image of an iteration stage and those of the previous iteration stage is compared to a sum of the same pixel-by-pixel values, i.e. a sum of the sums of the deconvolved image of an iteration stage and those of the previous iteration stage.

In the European disclosure document EP 4 198 879 A1, a method for enhancing image data in real time is proposed in which a denoising step and a deconvolution step are separated. The denoising step may include subtracting a background. An enhanced image is obtained by superimposing a denoised image and a deconvolved image. The weighting of the overlay depends on the sampling interval with which a sample was scanned. If the sample was oversampled according to the Nyquist criterion, the deconvolved image is weighted heavily; if it was undersampled, the deconvolved image is weighted lightly.

European Publication EP 4 345 735 A1 describes a special method for improving images on the basis of temporal image series, in particular those recorded according to the principle of super-resolution optical fluctuation imaging (SOFI). In one embodiment, the method comprises estimating a background for each individual image on the basis of a wavelet transform and the back-transformation of the lowest frequency component. The value obtained after the reverse transformation is compared with a value corresponding to half the square root of the value of the original image, and the smaller of the two values is assumed to be the low-frequency background. The process is continued iteratively, whereby the background image obtained from the previous stage is used as the new input image. The resulting background is then subtracted from the corresponding individual image in the image series. The images reduced by the background are then unfolded.

In the publication “Iterative Algorithms Based on Decoupling of Deblurring and Denoising for Image Restoration” (You-Wei Wen et al.; SIAM J. Sci. Comput. 30, 5 (June 2008), 2655-2674; DOI: 10.1137/070683374), various methods for image denoising and various methods for image deblurring are named. It is found that noisy images are regularly processed in a way in which noise is taken into account at each deconvolution step in an iterative deconvolution. For images that can be understood as the result of an image of an object with a location-independent point spread function and the superposition with a mean-free Gaussian noise, the authors now propose to separate denoising steps and deconvolution steps in the individual iteration steps.

With iterative deconvolution methods, the problem often arises that an over-adjustment to image noise takes place and that artifacts appear in deconvolved images, which can be related to the image noise.

### TASK OF THE INVENTION

It is now the task of the present invention to specify methods and devices for image acquisition with which artifact-free or at least artifact-reduced deconvolved images are obtained.

### SOLUTION

This task is attained by the subject matter of independent claims. Advantageous embodiments of the method and the light microscope are given in the subclaims and are described below.

### DESCRIPTION OF THE INVENTION

A first aspect of the invention relates to a method for obtaining deconvolved images using an iterative deconvolution with a deconvolution rule underlying the deconvolution comprising the steps of:
a light microscopic recording of image data of a sample area of a sample to be imaged, whereby emissions from the sample are recorded with a detector,
based on the data, a first image and a second image of the sample area are generated, whereby noise components of the first image and the second image are statistically independent of each other, whereby the images have pixels and values assigned to the pixels,
determining or setting a first input estimate of an ideal image of the sample area, a second input estimate of an ideal image of the sample area and a further input estimate of an ideal image of the sample area, wherein the input estimates comprise pixels and values associated with the pixels,
on the basis of the first image and the first input estimate, determining a first relation between a first output estimate of the ideal image of the sample area, which results from the application of the deconvolution rule to the first input estimate, and the first input estimate, and on the basis of the second image and the second input estimate, determining a second relation between a second output estimate of the ideal image of the sample area, which results from the application of the deconvolution rule to the second input estimate, and the second input estimate,
for each pixel a checking of the deviation between the first and the second relation or a checking whether the first and the second relation are identical or not identical,
determining a further output estimate of the ideal image of the sample area based on an image, which may be a further image or the first or the second image, and based on a further input estimate according to an adapted deconvolution rule corresponding to the deconvolution rule, with the exception in that, according to the adapted deconvolution rule, a value of the further output estimate for the pixels is set equal to the value of the further input estimate for which the deviation between the first and the second relation exceeds a threshold value or for which the first and the second relation are not identical.

A second aspect of the invention relates to a device for obtaining deconvolved images using an iterative deconvolution with a deconvolution rule underlying the deconvolution, the device comprising:
a detector configured to acquire image data of a sample area of a sample by detecting emissions from the sample during light microscopic imaging;
a processor configured to:
   generate, based on the image data, a first image and a second image of the sample area, wherein noise components of the first image and the second image are statistically independent of each other, and wherein the images comprise pixels and values assigned to the pixels;
   determine or set a first input estimate, a second input estimate, and a further input estimate of an ideal image of the sample area, wherein the input estimates comprise pixels and values associated with the pixels;
   determine, based on the first image and the first input estimate, a first relation between a first output estimate of the ideal image of the sample area—resulting from the application of the deconvolution rule to the first input estimate—and the first input estimate;
   determine, based on the second image and the second input estimate, a second relation between a second output estimate of the ideal image of the sample area-resulting from the application of the deconvolution rule to the second input estimate-and the second input estimate;
   check, for each pixel, a deviation between the first and second relation or whether the first and second relation are identical or not identical;
   determine, according to an adapted deconvolution rule, a further output estimate of the ideal image of the sample area based on an image, which may be a further image or the first or the second image, and based on the further input estimate, wherein the adapted deconvolution rule corresponds to the deconvolution rule, except that, according to the adapted deconvolution rule, a value of the further output estimate for the pixels is set equal to the value of the further input estimate for which the deviation between the first and second relation exceeds a threshold value or for which the first and second relation are not identical;
a memory for storing the image data, the input estimates, and the output estimates.

In one embodiment, the device comprises a display as one user interface for showing image data. For example an output estimate can be displayed on this user interface as an image. If it is volume data that has been unfolded, the output estimate can be presented to the user in a suitable form.

In one embodiment, the device has a user interface for receiving user input. The user inputs may, for example, concern the selection of the image data to be deconvolved or the selection of a deconvolution rule or the selection of parameters of a deconvolution rule. The image data of the sample area to be imaged can be recorded using various light microscopy methods. Depending on the object to be imaged, for example, reflected light microscopes, transmitted light microscopes, various types of wide-field microscopes, wide-field fluorescence microscopes or scanning microscopes can be used. The combination of different microscopy methods, for example wide-field fluorescence microscopy with scanning microscopy or simple confocal scanning microscopy with STED microscopy, can also be used to advantage. Suitable detectors are used depending on the method used.

The image data obtained during recording contains information from which images of the sample area to be imaged can be generated. Image data is understood to be data in which assignment of values to locations in the sample area to be imaged is given. This sample area can extend in one dimension, it can form a surface, in particular a flat surface, or it can comprise a volume. The images can therefore represent a line, a surface or a volume. It is not necessary for an image to be displayed or displayable as an picture. It is essential for an image that there is an assignment of the elements of the image, which are subsequently referred to as pixels, to corresponding elements of the sample, whereby this assignment results from the optical properties of the system used for imaging. The essential property for the imaging process is described by a point spread function. The pixels form an ordered set, whereby a coordinate can be assigned to each pixel within the set of pixels. Each pixel is assigned a value.

Two images of the sample area, referred to as the first image and the second image, are generated on the basis of this image data. The first image and the second image are images of the sample area, which means that they are images of the same area, i.e. they do not relate to different parts of the sample. The first and second images do not serve to be displayed to the user as an picture, even if it is conceivable that the first or second image is displayed, but they serve as a means of optimizing the unfolding of a further image, as will be explained later. In order for the first and second images to fulfill their purpose, it is important that the noise components of the first and second images are statistically independent of each other. The fact that noise components are statistically independent does not mean that all noise components are statistically independent. A complete statistical independence of all noise components cannot be achieved in many cases, for example if a camera shows a fixed pattern noise or dark noise. Statistical independence can be achieved in different ways for the noise components that result from the fact that imaging is ultimately carried out using photons, i.e. noise components that correspond to Poisson noise. In many microscopy applications, this Poissonian photon noise is the dominant noise. This is particularly true in laser scanning microscopy, where, for example, detectors such as photoelectron multipliers or avalanche photodiodes or arrays of avalanche photodiodes or hybrid photodetectors are used, which are often operated in a photon-counting mode and in particular have very low dark noise. Statistical independence of noise components can therefore be understood as the statistical independence of photon noise. Statistical independence of noise components or photon noise can be realized in various ways, as will be explained later.

An iterative deconvolution is a process in which, starting from an estimate of an ideal image, an improvement of the estimate of the ideal image is iteratively generated according to a deconvolution rule using the actual image. An ideal image is understood here to be an image that would result if the point spread function of the imaging system were infinitely “narrow”, i.e. if the system were to direct all emissions originating from the same point in the sample area to exactly one point in the detection area. The term “object function” is also used for this in the specialist literature. At the start of a deconvolution, this ideal image must therefore be estimated. For example, an actual image can be used as an initial estimate of the ideal image. In many cases, each pixel of the ideal image is filled with the same value for an initial estimate of the ideal image, whereby the sum of all values can correspond to the sum of all values of the actual image. In a second deconvolution step, the result of the first deconvolution step is then used as an estimate of the ideal image in the case of simple deconvolution. If several images are used, an improved estimate of the ideal image obtained in another way can also be used for one image in the second step. When determining or setting, an estimate of the ideal image is either determined or set, i.e.

selected or arbitrarily set. This estimate is referred to here as the input estimate. In the determing or setting step, input estimates are determined or set that are assigned to one image in each case. In addition to the first image and the second image, this is another image. The further image is the image that is ultimately unfolded. In that. the further image can also be the first image or the second image. In such a case, one of the images fulfills a double role. The input estimates can be identical to each other or identical except for a scaling factor

As part of an iterative unfolding process, an improved estimate is obtained in each step based on an input estimate. This improved estimate is referred to here as the output estimate. This output estimate differs from the input estimate. The values of the output estimate can therefore be set for each pixel in relation to the values of the input estimate. Pixels can also be grouped, for example by forming mean values, and then put into relation. This can mean, for example, that a difference or a ratio of the values of the input estimate and the output estimate is formed. For each pixel, a value can be greater than, equal to or less than the value of the output estimate. In an advantageous embodiment, the relation in which the values of the output estimate and the input estimate are set can be an actual greater than or equal to relation. Depending on the deconvolution rule, such a relation can also be determined without carrying out the deconvolution step completely. For example, in the case of deconvolution according to the rule

$${x}^{k + 1} = {x}^{k} \cdot {H}^{T} \frac{{y}_{i}}{H {x}^{k}} ,$$

in which the term H x^{k} denotes a convolution of the ideal image or the object function x^{k} with the point spread function H of the imaging process and HT is an operator derived from the point spread function, it is sufficient to evaluate the term

$${H}^{T} \frac{{y}_{i}}{H {x}^{k}}$$

in each case, when can assume a value from 1 or a value less than 1 for each pixel. If the value of this term is less than 1, it is clear that the output estimate will be less than the input estimate; conversely, it is clear that the output estimate will be greater than or equal to the input estimate. According to the deconvolution rule, it may even be sufficient to only evaluate the term

$$\frac{{y}_{i}}{H {x}^{k}} .$$

In a subsequent step, the deviation between the first and second relation is checked for each pixel. If the relations are each expressed by a numerical value, this can mean that a difference or a ratio of the relations is formed in each case. In this case, a threshold value is used in the following step. In an advantageous embodiment, the relations are actual-greater-than-or-equal-to relations. In this case, it is checked whether the first and second relations are identical or not identical, i.e. whether the difference between the output estimate and the input estimate has the same sign in both cases, e.g. whether it is positive in both cases or not. The result of the check determines the details of the design of the deconvolution rule in the following step.

The deconvolution rule for the further image is adjusted according to the result of the relation check. In areas in which the deviation of the relations exceeds a threshold value, which in the case that the relations are simple actual greater than or equal to relations means that the relations are not identical, there is a higher probability that the result of the deconvolution step is decisively related to the random properties of the images, but not to the imaginary ideal image of the sample area. If the first image and the second image in both cases were images that are completely free of noise influences, there would be no deviation between the relations. The greater the deviation of the relations, the greater the probability that in at least one of the images, i.e. the first or the second image or in both images, the relevant deconvolution step for the relevant pixel or for a area of pixels is essentially determined by the specific realization of the noise in the image. Conversely, if the relations show no or a small deviation, the probability is high that the result of the deconvolution step is determined by the imaginary ideal image, i.e. by the actual object function. In the advantageous case that the relations are actual greater than or equal to relations, as explained above, it is assumed that the probability that the deconvolution step is determined by the noise is particularly high if the deconvolution step leads to an increase in the value of a pixel in the first image and to a decrease in the value of a pixel in the second image, or vice versa. In order to ensure that the deconvolution step is carried out in a way not leading to artifacts where it is most likely to be determined by noise, i.e. for the pixels in question, the deconvolution rule for the actual execution of the deconvolution step of the image that is actually to be deconvolved and not just for control purposes is adapted in such a way that for these pixels the value of the output estimate is left at the value of the input estimate. The image in question, which is actually deconvolved, is referred to here as further image. The further image may, for example, be a sum of the first image and the second image, it may, if the image was obtained by confocal scanning using an array detector, be a sum or a Sheppard sum of the individual images obtained with the array. Further explanations of the images, the first image, the second image and the further image can be found in the following text.

As part of an iterative continuation, the results of the check can also be used to define a termination criterion. For example, it can be specified that the iteration of the unfolding is terminated if the check is negative for a certain proportion of all pixels in the images. Alternatively or additionally, it can be specified that the iteration of the deconvolution is terminated locally if, within a specified number of repetitions, for example five or ten repetitions, the check is negative several times, for example twice, three times or five times, or if it is negative several times in successive steps of the iteration. These criteria can be applied both to individual pixels and to areas surrounding pixels to which the above applies; this means that the deconvolution can then be aborted for an area of a defined size, for example for an array of pixels surrounding the pixel in question, or also for the entire sample area. However, one advantage of the proposed solution is that the deconvolution tends less than usual deconvolution to run towards artifacts. As a result, it is often sufficient to terminate the iteration only after a fixed number of steps, for example after 20 or after 30 or after 50 or after an even higher number of iteration steps, without the risk of obtaining artifact-laden deconvolution results, which can be seen in the images finally displayed. The unfolding rule can, for example, have the form

$${x}^{k + 1} = {x}^{k} \cdot {H}^{T} \frac{{y}_{i}}{H {x}^{k}} ,$$

which has already been introduced above. Other deconvolution rules known from the prior art can also be used in the context of the proposed solution. In an advantageous embodiment, the deconvolution rule comprises a pixel-wise forming of a ratio comprising an image in the numerator and a convolution of an input estimate of an ideal image with a point spread function or a sum of a convolution of an input estimate of an ideal image with a point spread function and one or more summands in the denominator. An example of such a deconvolution rule has the form

$${x}^{k + 1} = {x}^{k} \cdot {H}^{T} \frac{{y}_{i}}{H {x}^{k} + {S}_{1} + {S}_{2}} .$$

In addition to the summands S₁ and S₂, there could be further summands in the denominator that represent various influences of the imaging system or the sample that contains the sample area to be imaged on the image yᵢ. In particular, the summands can represent influences that are themselves subject to noise. For example, if a detector has an essentially constant offset, this can be taken into account when determining the images, in this case the image yᵢ. However, if the offset itself is subject to noise, it may be more favorable to take the offset or a portion of the offset into account during deconvolution by adding it pixel by pixel in the denominator to the imaginary image H x^{k} resulting from the estimate of the ideal image x^{k}, i.e. the convolution of the estimate of the ideal image and the point spread function on which the image is based.

The point spread function used in the deconvolution can be obtained in various ways, for example by a measurement on point emitters, from a model of the image or from any data by a suitable evaluation, for example using a Fourier ring correlation analysis (see, for example, the publication “A robust and versatile platform for image scanning microscopy enabling super-resolution FLIM” mentioned in the section on the state of the art). It is often useful, or strictly speaking not possible otherwise, to use a point spread function that is only different from 0 within a limited range instead of a point spread function that completely describes an actual image of a point light source. As a result, it is useful to consider that an actual imaging will also capture emissions that originate from areas of the sample that are not captured by the point spread function used for the sample area to be imaged. Such emissions, which form a background, can originate in particular from areas above and below (seen along an optical axis of the imaging system means below, further away from the detector or the objective than the sample area to be imaged) the sample area to be imaged at a distance from the sample area which is greater than the extent of the point spread function projected into the sample. In particular in connection with an image based on the principle of laser scanning microscopy, in which a laser light beam is focused onto or into the sample by means of an objective with which the sample area is scanned, these emissions can also originate from areas within the sample area to be imaged that lie to the side of the focal point. Particularly in laser scanning microscopy with the use of STED light, as is common in the prior art, these emissions from laterally located areas can be relevant because STED light can lead to a re-excitation of fluorophores in areas of high intensity, i.e. just laterally at a distance from the focal point. Due to the above-mentioned facts, among others, a deconvolution rule is therefore used in some advantageous embidments, in which a pixel-by-pixel formation of a ratio with an image in the numerator and a sum from a convolution of an input estimate of an ideal image with a point spread function and at least one summand takes place, whereby the summand represents a background, in particular background as described above, i.e. undesired emissions. In the event that there are further noisy sources of background, a relevant summand can represent such background or a summand is formed which represents an overall influence of this further noise source and the unwanted emissions.

In general, the detector can be a photon-counting detector. This has the advantage that influences from an unknown amplification of the detector are avoided. In addition, conventional photon-counting detectors have only a low level of dark noise. As a result, the influence of unavoidable photon noise dominates over all other noise influences. Examples of such detectors, namely photoelectron multipliers or avalanche photodiodes or arrays of avalanche photodiodes or hybrid photodetectors, have already been mentioned above.

In advantageous embodiments, the image data is recorded using a fluorescence microscope. The fluorescence microscope can, for example, be a wide-field fluorescence microscope or a light sheet microscope or a transmitted light fluorescence microscope. In advantageous embodiments, the sample area is illuminated with excitation light through an objective. In further advantageous embodiments, the illumination is carried out through an objective through which the emissions from the sample are also detected. Fluorescence microscopy methods allow the recording of image data of a sample area of a sample extended in three dimensions. Due to the size of the sample and the fact that the sample is often stained with fluorophores, which is not limited to the sample area to be imaged, unwanted emissions often occur in fluorescence microscopy, which have already been discussed above. For this reason, there is a particular need in fluorescence microscopy for deconvolution methods that take these unwanted emissions into account in a suitable manner. At the same time, the numbers of photons detected are often comparatively low, partly because fluorophores are bleached by the excitation. This is all the more true in STED microscopy. In fluorescence microscopy, especially in STED microscopy, the problems of high photon noise and a lot of unwanted emissions occur simultaneously. The solution proposed as an advantageous embodiment, in which a pixel-by-pixel formation of a ratio with an image in the numerator and a sum of a convolution of an input estimate of an ideal image with a point spread function and at least one summand representing unwanted emissions, is therefore of particular importance for fluorescence microscopy, especially for STED microscopy.

In conventional STED microscopy methods, as with laser scanning microscopes, the sample area to be imaged is scanned with focused excitation light. In most cases, the excitation light is focused in a diffraction-limited manner in such a way that the smallest possible volume or the smallest possible area of high illumination intensity around a central intensity maximum is achieved in a plane. The intensity distribution in the illumination focus can be deliberately chosen differently in some applications. The emissions from the sample, i.e. in particular the fluorescence excited by the excitation light, are imaged into a detection area by the same objective through which the focusing into the sample takes place, using further components, i.e. an intensity distribution is generated in the detection area for each imaginary point source which corresponds to the actual point spread function of the imaging system up to the detection area. Accordingly, in advantageous embodiments of the proposed solution, the optical microscopic acquisition of image data may comprise scanning the sample area to be imaged, wherein the excitation light is focused by an objective into a focus area and forms a focused excitation light, and confocal detection of emissions from the sample, wherein for the detection the emissions from the sample are passed through the objective and through a beam path with an optical axis imaging onto the detector. This does not mean that the detector must capture an image. Rather, the detector can be a single detector that has an aperture arranged confocal to the focus area, in particular a pinhole aperture. In this case, the detector detects the emissions that pass through or enter the aperture at each scanning point. The size of the aperture influences the actual point spread function of the system, which includes a broadening function of the excitation, particularly in the case of confocal fluorescence microscopy or STED microscopy. In STED microscopy methods, an area around a maximum of the intensity distribution of the focused excitation light in the focus area is superimposed with an area around a local minimum of a focused STED light during scanning. The fact that the aperture of the detector is arranged confocally means that the aperture is placed at the location at which the focus of the excitation light is projected by the imaging system.

Instead of a single detector, in advantageous embodiments in methods of the proposed solution in which the sample is scanned with focused excitation light, the detector can be an array detector suitable for locally resolving a diffraction image of a single point emitter in the plane conjugate to the emitter, the array detector comprising an array of several individual detectors. The use of array detectors in laser scanning microscopy is becoming increasingly widespread, which also has to do with the availability of particularly well-suited detectors such as arrays of avalanche photodiodes. However, the term array detector also covers detectors that have a number of apertures in the confocal area, through each of which the light passing through is guided to a separate associated detection element. One example is a fiber bundle whose free ends form or have the apertures in the detection area and whose other ends are each coupled to a detection element. The use of such an array detector has the advantage that image data is obtained directly, from which several images can be generated in a simple manner, which have statistically independent photon noise. This is because the image acquisition can be understood as a simultaneous acquisition of several individual image data sets of the same sample area, with a single image data set belonging to each individual detector element. The point spread functions belonging to the individual detectors of the array do differ. However, this is unproblematic with regard to the deconvolution, because in the case that a first image is generated for a first individual detector of the array and a second image is generated for a second detector of the array, the corresponding first point spread function is used in the deconvolution rule for the first image and the corresponding second point spread function is used for the second image. The photon noise is also independent if combined images are generated from image data for several individual detectors, provided that the two groups of individual detectors do not have a common element, i.e. no individual detector is assigned to both groups. The first image and the second image can also be selected from alternating sets of individual detectors in different stages of the iteration. This leads to a further reduction of the risk that the unfolding of the further image to be unfolded tends to develop artifacts. The first image and the second image can be formed from sums or Sheppard sums of the associated parts of the image data set. The same applies to the further image to be finally deconvolved, which can be formed from the image data of all individual detectors. Accordingly, in an advantageous embodiment of the proposed method, the first image may be generated from image data obtained in a detection of the emissions with a first set of individual detectors of the array detector, and the second image may be generated from image data obtained in a detection of the emissions with a second set of individual detectors of the array detector, wherein the first and the second set of individual detectors do not contain a common element.

The use of an array detector makes it possible to estimate the background for each pixel from the image data by comparing the emissions detected when scanning the sample area to be imaged with individual detectors located close to the optical axis with individual detectors located further away from the optical axis. Such a method for estimating the background is known, for example, from the international publication WO 2022/043438 A1.

In general, the excitation light may be pulsed, advantageously with a pulse duration shorter than a fluorescence lifetime of the fluorophores excited to fluorescence by the excitation light, or with a pulse duration shorter than one tenth of the fluorescence lifetime or shorter than 1 ns. Pulsed excitation light can be used for very different reasons. In principle, it can be used with all embodiments of the proposed method.

In general, the detection can be time-resolved. The time resolution can also generally be better than 1 ns or better than 100 ps.

A particular advantage arises in fluorescence microscopy methods, particularly in laser scanning methods, if the excitation light is pulsed and, in addition, the detection is time-resolved, particularly if the pulse durations of the pulses of the excitation light being short in relation to the fluorescence lifetime of the fluorophores to be excited and the time resolution being suitable for detecting fluorescence responses to individual pulses with temporal resolution. This can mean that a pulse duration of the excitation light is smaller than a fluorescence lifetime of the fluorophores that are excited to fluorescence by the excitation light, particularly smaller than one tenth of the fluorescence lifetime or smaller than 1 ns, and that the detection of the emissions is time-resolved, particularly with a time resolution better than 1 ns, more particularly with a time resolution better than 100 ps. Among other things, the pulsed excitation in conjunction with the time-resolved detection makes it possible to obtain detailed information about the lifetime of the fluorophores, which allows conclusions to be drawn about the environment of the fluorophores. Particularly advantageous embodiments of the proposed solution result from the pulsed excitation in conjunction with the time-resolved detection of the emissions, namely in which the first image and the second image are determined as a function of detection periods. Specifically, the first image can then be generated from image data representing emissions detected for each pulse of the excitation light within a first detection period after the pulse of the excitation light, and the second image can be generated from image data representing emissions detected for each pulse of the excitation light within a second detection period after the pulse of the excitation light, wherein the first and second detection periods do not overlap. This can be designed, for example, in such a way that the first detection period is continuous or that the second detection period is continuous or that both detection periods are continuous. In this case, the first and second detection periods are advantageously contiguous. The further image can then be formed from image data over the entire detection period for each excitation pulse

In a further embodiment of the methods with pulsed excitation and time-resolved detection of the fluorescence after individual pulses, the first and second detection periods are selected in such a way that, on average, the same amount of emissions is detected within the first detection period as within the second detection period. This can be achieved without prior knowledge of the fluorescence lifetime by interleaving the selected detection periods, which means that a first subperiod of the first detection period is followed by a first subperiod of the second detection period, which is followed by a second subperiod of the first detection period. If the fluorescence lifetime is known, the subperiods can be selected according to the fluorescence lifetime of the fluorophores, also particularly in such a way that on average the same amount of emissions is detected within the first detection period as within the second detection period.

Another way of obtaining two partial data sets whose photon noise is statistically independent when using pulsed excitation, even without time-resolved detection that temporally resolves the signal after a single pulse, is to sort emissions by pulse into two partial data sets. Instead of an alternating assignment to the partial data sets according to individual pulses, an alternating assignment according to groups of pulses can also be used. Such an assignment is easily possible in the context of laser scanning microscopy, especially when using photon-counting detectors.

It should be emphasized that the splitting of the image data into partial data sets to obtain a first and a second image, which are used to control the deployment of a further image, can be carried out not only when using a single detector, but also according to the above-mentioned methods using time-resolved acquisition if the detector is an array detector.

In particular, if the image data are recorded by means of STED microscopy, it is advantageous to use image data at different detection periods after a pulse of the excitation light to infer the amount of unwanted emissions in particular, which originate from STED re-excitation. Such a method is described in the publication “Two-Photon Excitation STED Microscopy with Time-Gated Detection” mentioned in the prior art section, which refers to a method in which the STED laser is not pulsed. Even when using pulsed STED light, conclusions about undesired emissions can be drawn from an examination of image data of a time-resolved detection, as stated above.

In addition to the above-mentioned options for the simultaneous acquisition of image data with partial data sets, from which images can be easily generated that are independent with regard to photon noise, there are other options. One possibility is the acquisition of fluorescence in several spectral bands or ranges. In this case, a first image can be generated from image data for one spectral range and a second image from another spectral range, which can be used to control the deconvolution of the further image according to the procedure. The further image can then be formed from the sum of several spectral channels. Two spectral channels are sufficient for this, which can be generated using a dichroic beam splitter, for example.

Another option for laser scanning microscopy is to scan at high resolution and sort the image data pixel by pixel (in this case, the pixels are defined by a pixel dwell time and a scanning speed) or line by line alternately into two partial data sets. Here too, the partial images are based on the same sample area. If the data is not recorded simultaneously or at least quasi-simultaneously, image data can also simply be recorded frame by frame, i.e. the same sample area is imaged twice in succession as a whole. The sample area can also comprise a volume.

However, the proposed method does not depend on the use of means such as time-resolved detection of emissions, use of an array detector or spectrally separated detection. Although the embodiment described below is also applicable if such means are available, it is not dependent on their use. In this further embodiment, which does not depend on the above-mentioned means, a main image is generated from the image data, the main image comprising pixels and values assigned to the pixels from the set of natural numbers including 0; then the first image and the second image are derived from the main image by taking the associated value for each pixel as a set of individual counts and by determining for each count, according to a randomization rule simulating or representing a Bernoulli chain, whether the count is assigned to the pixel of the first image associated with the count or to the pixel of the second image associated with the count.

Since this process divides the main image into partial images according to an appropriate randomization rule, the photon noise in both partial images is independent of each other. The two partial images are then used as the control images for the deconvolution of a further image. This further image can be the main image. Instead of the main image, the entire set of image data can be divided in a corresponding manner if the image data is available as a pixel data set with assigned integer values from the set of natural numbers including 0 or can be understood as such. Such an implementation is considered by the applicant to be equivalent to that described above.

In one embodiment of the method in which a random division of image data or the main image is performed, the probability of being assigned to the first image/first partial data set or the second image/second partial data set is set equal to 0.5 for each count of the main image or image data. This has the effect that the sum value of the detected emissions in both images/partial data sets is the same within the limits caused by the noise.

However, a method in which a random process is used in the strict sense has a critical disadvantage under certain circumstances, namely that the process is not reproducible for systematic reasons. To counter this disadvantage, a pseudo-random process is used in a particular embodiment of the proposed method, which ensures that identical first images/first partial data sets and identical second images/second partial data sets are repeatedly reproduced when the pseudo-random process is repeatedly applied to the same main image/data set. For reasons of simplification, the pseudo-random process is subsumed under the term random process.

A main image in the above sense can also be formed if the data was generated using means such as time-resolved detection of the emissions, use of an array detector or spectrally separated detection. For example, when using an array detector in the context of laser scanning microscopy, the image data set can be grouped in such a way that a sum value is formed from the values for the individual detectors for each scanning point, or that, if an image of a flat sample area is viewed, a sum image is generated from the images for the individual detectors of the array detector; the sum image can be a Sheppard sum image.

It has been explained elsewhere how a background representing unwanted emissions can be determined when using an array detector. However, special equipment is not necessarily required for the determination, i.e. estimation, of such a background. As is known from the prior art, a method based on a wavelet transform can be used. In an advantageous embodiment of the proposed method, the background is determined on the basis of a wavelet transform.

In the case of iterative deconvolution, as already mentioned above, an estimate is required for the object function or, as formulated in the context of this application, an ideal image. In the proposed method, such an estimate is required, so to speak, at several points, namely in the context of the control steps according to the deconvolution rule at the two images used to control the deconvolution of a further image, referred to here as first image and second image, and in the context of the deconvolution of the further image. It should be mentioned once again that the further image can also be the first image or the second image. In some embodiments, the further image is a sum of the first image and the second image. In the context of the deconvolution, an improved estimate is obtained from an estimate that that goes into the deconvolution, which is the result of the deconvolution, i.e. forms the output of the deconvolution step. Accordingly, the estimate that goes into a deconvolution step is referred to here as the input estimate and the result of a deconvolution step is referred to as the output estimate. In many deconvolution methods, the output estimate of an iteration step forms the input estimate of the following iteration step. However, this is not necessarily the case, at least for multi-image deconvolution. Since all images, first image, second image and further image, are images of the same sample area, in the context of the proposed method it is advantageous that the first input estimate, the second input estimate and the further input estimate are identical or identical except for a scaling factor, if necessary depending on the normalizations selected for the implementation of the method.

The aim of iterative deconvolution is usually to obtain a displayable image that reflects the structures of the sample area to be imaged as accurately as possible. The description above essentially refers to a single stage of iteration. This stage may be the first. Further parts of the description concern the acquisition of the image data, which precedes the deconvolution. A paragraph dealing with termination criteria for iterative deconvolution can also be found above.

In the proposed method, the following steps are carried out repeatedly after all the method steps have been carried out for the first time
determining or setting a new first input estimate of an ideal image of the sample area, a new second input estimate of an ideal image of the sample area and a new further input estimate of an ideal image of the sample area, wherein the input estimates comprise pixels and values associated with the pixels,
on the basis of the first image or a new first image and the new first input estimate, determining a first relation between a new first output estimate of the ideal image of the sample area, which results from the application of the deconvolution rule to the new first input estimate, and the new first input estimate, and, on the basis of the second image or a new second image and the new second input estimate, determining a second relation between a new second output estimate, which results from the application of the deconvolution rule to the new second input estimate, and the new second input estimate,
for each pixel a checking of the deviation between the first and the second relation or a checking whether the first and second relations are identical or not,
determining a new further output estimate of the ideal image of the sample area based on an image, which may be a further image or the first or the second image, and based on a new further input estimate according to an adapted deconvolution rule corresponding to the deconvolution rule, with the exception in that according to the adapted deconvolution rule, a value of the new further output estimate for the pixels is set equal to the value of the new further input estimate for which the deviation between the first and the second relation exceeds a threshold value or the first and second relations are not identical.

This means that the steps of unfolding and checking the unfolding are performed repeatedly. In each individual step of the iteration, unfolding rules or at least parts of unfolding rules are applied to several images, at least two if the further image, i.e. the image to be finally unfolded, is one of the control images, otherwise three images. In a sense, the method has three strands. In particular, these three strands are not considered independently. In principle, the associated deconvolution step can actually be carried out in each sub-strand and the result of each sub-strand, i.e. the respective output estimate, can be used as an input estimate for the following iteration step. However, it has proven to be advantageous to use the output estimate resulting from the deconvolution of the further image for each of the sub-strands as the input estimate for all sub-strands of the following iteration step or to derive the input estimate of the following step for all sub-strands from the output estimate for the further image. Depending on the exact implementation and normalization, scaling is necessary to adapt to the overall signal of the corresponding input image. Accordingly, in this embodiment, the new first input estimate and the new second input estimate and the new further input estimate are identical or identical except for a scaling factor. Furthermore, in this embodiment, the new first input estimate and the new second input estimate and the new further input estimate are identical to the output estimate of the previous iteration or are identical except for a scaling factor.

A further measure to reduce the risk of artifacts resulting from the deconvolution can be achieved by performing the step of determining a first relation based on a new first image and/or performing the step of determining a second relation based on a new second image, wherein new first image and/or the new second image are determined according to one of the described methods for obtaining the first image and the second image. This means that during repeated execution, the images used to control the deconvolution are varied.

Repeating can be carried out until a preselected number of steps is reached or when a termination criterion is reached. This has already been discussed elsewhere.

Finally, which is usually the goal of unfolding, another output estimate can be displayed on a user interface as an image. If it is volume data that has been unfolded, it is presented to the user in a suitable form.

1. Method for obtaining deconvolved images using an iterative deconvolution with a deconvolution rule underlying the deconvolution comprising:
a light microscopic recording of image data of a sample area of a sample to be imaged, whereby emissions from the sample are recorded with a detector,
based on the image data, generating a first image and a second image of the sample area, whereby noise components of the first image and the second image are statistically independent of each other, whereby the images have pixels and values assigned to the pixels,
determining or setting a first input estimate of an ideal image of the sample area, a second input estimate of an ideal image of the sample area and a further input estimate of an ideal image of the sample area, wherein the input estimates comprise pixels and values associated with the pixels,
on the basis of the first image and the first input estimate, determining a first relation between a first output estimate of the ideal image of the sample area, which results from the application of the deconvolution rule to the first input estimate, and the first input estimate, and, on the basis of the second image and the second input estimate, determining a second relation between a second output estimate of the ideal image of the sample area, which results from the application of the deconvolution rule to the second input estimate, and the second input estimate,
for each pixel a checking of the deviation between the first and the second relation or a checking whether the first and the second relation are identical or not identical,
determining according to an adapted deconvolution rule a further output estimate of the ideal image of the sample area based on an image, which may be a further image or the first or the second image, and based on a further input estimate, wherein the adapted deconvolution rule corresponds to the deconvolution rule, with the exception in that, according to the adapted deconvolution rule, a value of the further output estimate for the pixels is set equal to the value of the further input estimate for which the deviation between the first and the second relation exceeds a threshold value or for which the first and the second relation are not identical.

2. The method according to claim 1, wherein the deconvolution rule comprises a pixel-wise forming of a ratio with an image in the numerator and a convolution of an input estimate of an ideal image with a point spread function or a sum of a convolution of an input estimate of an ideal image with a point spread function and one or more summands in the denominator.

3. The method according to claim 2, wherein the denominator comprises a summand representing a background.

4. The method according to claim 3, wherein the background represents unwanted emissions from the sample.

5. The method according to claim 1, wherein the light microscopic recording of image data comprises illuminating the sample through an objective with excitation light which excites fluorophores to fluorescence, and detecting emissions from the sample.

6. The method according to claim 5, wherein the optical microscopic acquisition of image data comprises scanning the sample area to be imaged, wherein the excitation light is focused by the objective into a focus area and forms a focused excitation light, and comprises confocal detection of emissions from the sample, wherein for the detection the emissions from the sample are passed through the objective and through a beam path with an optical axis imaging onto the detector.

7. The method according to claim 6, wherein during scanning, a region around a maximum of the intensity distribution of the focused excitation light in the focus region is superimposed in each case with a region around a local minimum of a focused STED light.

8. The method according to claim 6, wherein the detector is an individual detector which has an aperture, in particular a pinhole aperture, arranged confocal to the focus area.

9. The method according to claim 6, wherein the detector is an array detector which is suitable for locally resolving a diffraction image of a single point-like emitter in the plane conjugate to the emitter, the array detector comprising an array of a plurality of individual detectors.

10. The method according to claim 9, wherein the deconvolution rule comprises a pixel-wise forming of a ratio with an image in the numerator and a convolution of an input estimate of an ideal image with a point spread function or a sum of a convolution of an input estimate of an ideal image with a point spread function and one or more summands in the denominator, wherein the denominator comprises a summand representing a background, which represents unwanted emissions from the sample, wherein the background is estimated from the image data for each pixel by comparing the emissions detected during the scanning of the sample area to be imaged with individual detectors located close to the optical axis with individual detectors located further away from the optical axis.

11. The method according to claim 9, wherein the first image is generated from image data obtained in a detection of the emissions with a first set of individual detectors of the array detector, and in that the second image is generated from image data obtained in a detection of the emissions with a second set of individual detectors of the array detector, wherein the first and the second set of individual detectors do not contain a common element.

12. The method according to claim 5, wherein the excitation light is pulsed, a pulse duration being shorter than a fluorescence lifetime of the fluorophores which are excited to fluorescence by the excitation light.

13. The method according to claim 12, wherein the first image is generated from image data representing emissions detected for each pulse of the excitation light within a first detection period after the pulse of the excitation light, respectively, and that the second image is generated from image data representing emissions detected for each pulse of the excitation light within a second detection period after the pulse of the excitation light, respectively, wherein the first and second detection periods do not overlap.

14. The method according to claim 13, wherein the first and second detection periods are selected according to the fluorescence lifetime of the fluorophores in such a way that on average the same amount of emissions is detected within the first detection period as within the second detection period.

15. The method according to claim 1, wherein a main image is generated from the image data, the main image having pixels and values assigned to the pixels from the set of natural numbers including the 0, and wherein the first image and the second image are derived from the main image, and wherein for each pixel the assigned value is understood as a set of individual counts and wherein for each count it is determined according to a randomization rule which simulates or represents a Bernoulli chain whether the count is assigned to the pixel of the first image associated with the count or to the pixel of the second image associated with the count.

16. The method according to claim 15, wherein for each count of the main image, the probability of being assigned to the first image or the second image is equal to 0.5 in each case.

17. The method according to claim 15, wherein the random rule repeatedly reproduces mutually identical first images and mutually identical second images when repeatedly applied to the same main image.

18. The method according to claim 1, wherein after a first execution of all method steps, the following steps are performed repeatedly:
determining or setting a new first input estimate of an ideal image of the sample area, a new second input estimate of an ideal image of the sample area and a new further input estimate of an ideal image of the sample area, wherein the input estimates comprise pixels and values associated with the pixels,
on the basis of the first image or a new first image and the new first input estimate, determining a first relation between a new first output estimate of the ideal image of the sample area, which results from the application of the deconvolution rule to the new first input estimate, and the new first input estimate, and, on the basis of the second image or a new second image and the new second input estimate, determining a second relation between a new second estimate, which results from the application of the deconvolution rule to the new second input estimate, and the new second input estimate,
for each pixel a checking of the deviation between the first and the second relation or a checking whether the first and the second relation are identical or not identical,
determining a new further output estimate of the ideal image of the sample area based on an image, which may be a further image or the first or the second image, and based on a new further input estimate according to an adapted deconvolution rule corresponding to the deconvolution rule, with the exception of in that, according to the adapted deconvolution rule, a value of the new further output estimate for the pixels is set equal to the value of the new further input estimate for which the deviation between the first and the second relation exceeds a threshold value or for which the first and the second relation are not identical.

19. The method according to claim 18, wherein the new first input estimate and the new second input estimate and the new further input estimate are identical to the output estimate of the preceding iteration or are identical except for a scaling factor.

20. A device for obtaining deconvolved images using an iterative deconvolution with a deconvolution rule underlying the deconvolution, the device comprising:
a detector configured to acquire image data of a sample area of a sample by detecting emissions from the sample during light microscopic imaging;
a processor configured to:
generate, based on the image data, a first image and a second image of the sample area, wherein noise components of the first image and the second image are statistically independent of each other, and wherein the images comprise pixels and values assigned to the pixels;
determine or set a first input estimate, a second input estimate, and a further input estimate of an ideal image of the sample area, wherein the input estimates comprise pixels and values associated with the pixels;
determine, based on the first image and the first input estimate, a first relation between a first output estimate of the ideal image of the sample area—resulting from the application of the deconvolution rule to the first input estimate—and the first input estimate;
determine, based on the second image and the second input estimate, a second relation between a second output estimate of the ideal image of the sample area-resulting from the application of the deconvolution rule to the second input estimate-and the second input estimate;
check, for each pixel, a deviation between the first and second relation or whether the first and second relation are identical or not identical;
determine, according to an adapted deconvolution rule, a further output estimate of the ideal image of the sample area based on an image, which may be a further image or the first or the second image, and based on the further input estimate, wherein the adapted deconvolution rule corresponds to the deconvolution rule, except that, according to the adapted deconvolution rule, a value of the further output estimate for the pixels is set equal to the value of the further input estimate for which the deviation between the first and second relation exceeds a threshold value or for which the first and second relation are not identical;
a memory for storing the image data, the input estimates, and the output estimates.
